(19) United States
(12) Patent Application Publication
(10) Pub. No.: US 2026/0119359 A1
(43) Pub. Date: Apr. 30, 2026

(54) MANAGING ADAPTABILITY OF ARTIFICIAL INTELLIGENCE BASED SYSTEMS

(71) Applicant: Dell Products L.P., Round Rock, TX (US)

(72) Inventor: DHARMESH M. PATEL, Round Rock, TX (US)

(21) Appl. No.: 18/932,786

(22) Filed: Oct. 31, 2024

(51) Int. Cl. G06F 11/34; G06F 11/36

(52) U.S. Cl. CPC G06F 11/3409; G06F 11/3672

(57) ABSTRACT

Methods and systems for managing operation of a system are disclosed. Architectural information for the system (e.g., indicating performance of the system) may be obtained while the system is providing a first computer-implemented service. A testing process may be performed using the architectural information and a knowledge base that includes architectural requirements for providing a second computer-implemented service. During the testing process, a performance limitation for the system that prevents the system from providing the second computer-implemented service in a desired manner may be identified. Based on the performance limitation, an action for updating the operation of the system may be identified. The action may be performed to update the operation of the system to increase a likelihood of the system providing at least the second computer-implemented service in the desired manner.

### FIELD

Embodiments disclosed herein relate generally to managing data processing systems. More particularly, embodiments disclosed herein relate to systems and methods to manage the operation of the artificial intelligence (AI) based systems.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a distributed system in accordance with an embodiment.

FIG. 2 shows a data flow diagram illustrating operations performed when managing operation of a system in accordance with an embodiment.

FIG. 3 shows a flow diagram illustrating a method for managing operation of a system in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing data processing systems that may provide, at least in part, computer-implemented services. For example, managed systems (e.g., systems managed and/or maintained by a third party) may provide artificial intelligence (AI) based services to data processing systems and/or other downstream consumers of the services.

To provide the services, the system (e.g., a managed system) may include hardware components and/or software components. Cooperative operation of these components may facilitate various functionalities of the system, thereby causing the system to provide the services. A system architecture may be used to define structures of the components (e.g., hardware structures, software structures) and/or behaviors of the system (e.g., configuration settings that define interactions between the components) so that the services are provided as desired. For example, the system may be designed to meet architectural requirements for providing a specific AI-based service in a desired manner, and may therefore be inflexible with respect to providing other AI-based services with different architectural requirements.

In some situations, the system may be unlikely to provide services in a desired manner, for example, due to performance limitations (e.g., reductions in performance and/or capabilities of the components over time, inherent operational capacities of the components, and/or limitations imposed by the system architecture). For example, as AI technology improves and as new AI-based services are adopted by an industry, the performance limitations may prevent the system from providing the new services at least in a desired manner; therefore, the performance limitations must be managed before the new services are adopted by the system. To do so, operation of the system may be updated by modifying to the system architecture (e.g., components thereof) to meet architectural requirements for providing the new services in the desired manner.

However, reactive updates to the operation of the system may result to delays in the system providing the latest services due to the time required to plan and/or implement modifications to the system architecture. For example, time implications for identifying the performance limitations, obtaining new components to manage the performance limitations, installing the new components to the system, and/or cost implications (e.g., large spends over small periods of time) may increase update lead time, resulting in a perpetual inability of the system to provide the latest services over time.

Thus, to increase a likelihood of the system providing the latest services over time, adaptability (e.g., flexibility) of the system architecture with respect providing anticipated computer-implemented services may be managed. To do so, a management entity for the system may test performance of the system with respect to anticipated (e.g., predicted) improvements in services (e.g., AI-based services). The management entity may perform testing processes using architectural information for the system and a knowledge base of capabilities required by anticipated AI-based services likely to be adopted by the system at future points in time. The testing process may be performed to identify performance limitations for the system over time that may prevent desired provisioning of the anticipated services. Results of the testing process may be used to plan a timeline of strategic modifications to the system architecture that may be implemented automatically by the management entity, thereby reducing lead time for updating operation of the system over time.

By doing so, modifications to the system architecture (e.g., updates to the operation of the system) may be managed proactively to reduce a likelihood of delaying provisioning of the latest services over time.

In an embodiment, a method for managing operation of a system is provided. The method may include: obtaining architectural information for the system, the architectural information indicating at least performance of the system while the system is providing a first computer-implemented service; performing a testing process using the architectural information and a knowledge base including architectural requirements for providing a second computer-implemented service to identify a performance limitation for the system, the performance limitation preventing the system from providing the second computer-implemented service in a desired manner; identifying, based in part, on the performance limitation, an action for updating the operation of the system; and, performing the action to update the operation of the system to increase a likelihood of the system providing at least the second computer-implemented service in the desired manner.

The system may include a managed artificial intelligence based system adapted to provide artificial intelligence based services.

The architectural information may include information regarding components of the system, the information including: software component data for software components that provide the artificial intelligence based services; hardware component data for hardware components used by the software components; and, configuration settings that define interactions between the software components and the hardware components.

The knowledge base may be based on predictions regarding capabilities required by artificial intelligence based services likely to be available for use by an operator of the system at a future point in time.

The testing process may include inferring a reduction in capabilities of the system at a future point in time based on changes in functionality of the system over time. The testing process may include inferring a future point in time that an operator of the system is likely to adopt the second computer-implemented service. The testing process may include inferring a future point in time that the first computer-implemented service is rendered obsolete.

The action may include: providing a notification to an operator of the system, the notification indicating a recommendation for installing a new component to the system; and, obtaining an approval for installation of the new component to the system. The action may include modifying an architecture of the system using a new component. The action may include replacing use of a first artificial intelligence model for providing the first computer-implemented service with a second artificial intelligence model to reduce load on a hardware component of the system that is deemed likely to fail when placed under load.

A non-transitory media may include instructions that when executed by a processor cause the computer-implemented method to be performed.

The data processing system may include the non-transitory media and a processor, and may perform the computer-implemented method when the computer instructions are executed by the processor.

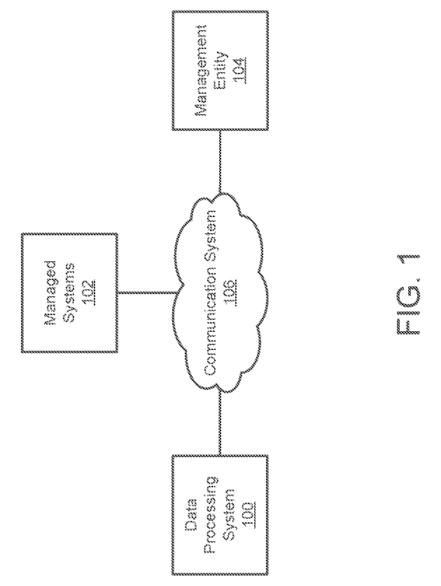

Turning to FIG. 1, a block diagram illustrating a distributed system in accordance with an embodiment is shown. The system shown in FIG. 1 may provide computer-implemented services. The computer-implemented services may include any type and quantity of computer-implemented services. For example, the computer-implemented services may include communication services, data storage services, database services, data generation services, and/or any other type of service that may be implemented with a computing device. Any of the services provided by the system may include AI-based services. Other types of services may be provided by the system shown in FIG. 1 without departing from embodiments disclosed herein.

To provide the (computer-implemented) services, the system may include any number of data processing systems (e.g., computing devices). The data processing systems may include any quantity of software components and/or hardware components. The components may include, for example, processors, memory modules, storage devices, communications devices, power components, software applications, device drivers, and/or any other type of component whose respective operation may facilitate various functionalities of the data processing systems. By facilitating such functionalities of the data processing systems, the respective operation of such components may cause the services to be provided.

The operation of the hardware and/or software components may be defined by system architectures for each of the data processing systems. For example, a system architecture may define (i) which of the components contribute to the operation, and/or (ii) how the contributing components are configured to interact with one another (or utilize various types and/or quantities of data during the operation). Consequently, if the system architecture (e.g., component architectures, performance capabilities of the components and/or configuration settings thereof) do not meet architectural requirements for providing the service, then the service may not be provided as desired (e.g., as intended by a developer of the service and/or as expected by a downstream consumer of such services).

For example, hardware and/or software components of a data processing system may be selected (e.g., based on operational capabilities) and may be configured to support provisioning of a first computer-implemented service in a desired manner. In other words, the architecture of the data processing system may be designed to meet architectural requirements for the first computer-implemented service (and/or other services with similar or same architectural requirements).

Over time, reductions in performance of the data processing system may cause the data processing system to be unable to provide the first computer-implemented service in the desired manner. For example, reductions in performance of software and/or hardware components (e.g., hardware and/or software degradation) over time may prevent the data processing system from providing the first computer-implemented service in the desired manner. Additionally, as relevant technology improves, the first computer-implemented service may be rendered obsolete. For example, the first computer-implemented service may become unsupported by a developer thereof, technologically of the first computer-implemented service may become out of date and/or undesired by downstream consumers, and/or the first computer-implemented service may be superseded by a second computer-implemented service.

However, as technology improves over time, architectural requirements for supporting new technology may also change. Therefore, architectural requirements for providing other services such as the second computer-implemented service may not be met by the data processing system, which may cause an interruption to the services expected by the downstream consumer. To update the system architecture of the data processing system so that architectural requirements for providing the second computer-implemented service are met, the data processing system may require (i) new hardware components (e.g., with increased performance capabilities), (ii) new software components, (iii) modifications to the configuration settings that define interactions between the hardware components and the software components, and/or (iv) other types of modifications to the system architecture that update operation of the data processing system.

Thus, to increase a likelihood of the data processing system providing the second computer-implemented service in the desired manner, new components may be identified, sourced (e.g., obtained from manufacturers), and installed, and operation of the components of the data processing system may be reconfigured. This process may be time consuming and/or may require manual efforts subject to error, especially when performed by an unseasoned operator of the data processing system under time constraints. Additionally, rates of improvement in relevant technology may exceed rates at which operation of the data processing system can be updated, making it difficult to adapt the data processing system to meet architectural requirements associated with the latest technology. As a result, the computer-implemented services may be interrupted and/or of reduced quality until the operation of the data processing system is updated accordingly.

In general, embodiments disclosed herein may provide methods, systems, and/or devices for managing adaptability of data processing systems over time in view of anticipated AI-based services likely to be adopted by the data processing systems over time. To do so, operation of the data processing systems may be managed by a management entity. The management entity may have access to a knowledge base that includes (i) information regarding predicted improvements in technology related to computer-implemented services provided by the data processing systems (e.g., information regarding anticipated services likely to be adopted by the data processing systems at a future point in time), (ii) information regarding predicted architectural requirements for services, and/or (iii) other information.

Using the knowledge base, the management entity may perform a testing process where architectural information for the data processing system is used to identify performance limitations (e.g., limitations imposed by the system architecture of the data processing system) that may prevent the data processing system from providing the anticipated services at future points in time. The testing process may provide information usable to generate actions for proactively managing adaptability of the data processing systems with respect to the performance limitations.

For example, the actions may be performed to reduce (e.g., prevent) delays in updating the operation of the data processing system before the anticipated services are adopted by the data processing systems. Portions of the actions may be performed automatically by the management entity to further reduce lead time. By doing so, the data processing systems may be more likely to provide desired computer-implemented services over time.

To provide the above-mentioned functionality, the distributed system of FIG. 1 may include data processing system 100, managed systems 102, management entity 104, and communication system 106. The distributed system, any components thereof, and/or any other types of devices or components not shown in FIG. 1 may perform all, or a portion of the computer-implemented services independently and/or cooperatively. Each of these components is discussed below.

Data processing system 100 may include any number of data processing systems. Data processing system 100 may host (and/or otherwise operate) any number of systems that provide, at least in part, computer-implemented services. For example, data processing system 100 may obtain a first portion of the computer-implemented services from any of managed systems 102 and/or provide a second portion of the computer-implemented services to other entities (e.g., a user of data processing system 100).

Data processing system 100 may be managed (e.g., operated) by an operator. The operation of data processing system 100 may be based on respective architectures of hosted systems (e.g., via internal networks of configured connections between the components). For example, data processing system 100 may host any of managed systems 102 to obtain and/or provide AI-based services.

Managed systems 102 may include any number of data processing systems managed on behalf of the operator of data processing system 100 by a management entity. For example, the management entity may include a manufacturer of managed systems 102 and/or a third-party service provider authorized by the operator to service and/or otherwise manage managed systems 102 based on an agreement (e.g., a service contract).

Managed systems 102 may include AI-based systems. For example, managed systems 102 may run any number and/or type of AI models that may be prompted (e.g., by data processing system 100) to provide AI-based services. Managed systems 102 may provide the AI-based services independently and/or cooperatively. For example, managed systems 102 may implement different system architectures that may be designed (e.g., optimized) for providing AI-based services using different types of AI models.

Management entity 104 may include any number of systems and may be tasked with managing operation of managed systems 102. For example, management entity 104 may manage the operation of managed systems 102 with respect to adaptability in view of anticipated technology (e.g., relevant to AI-based services) that may be adopted by any of managed systems 102 at future points in time.

To perform its functionality, management entity 104 may have access to a knowledge base. The knowledge base may be based on predictions regarding capabilities required by anticipated AI-based services likely to be available for use by the operator of managed systems 102 at future point in times. For example, the knowledge base may include architectural requirements for providing the anticipated AI-based services in a desired manner.

To manage adaptability of a system of managed systems 102, management entity 104 may (i) obtain architectural information for the system (e.g., information regarding components of the system and/or their configuration), (ii) perform testing processes using the architectural information and information from the knowledge base to identify performance limitations for the system that may prevent the system from providing anticipated services in a desired manner, (iii) identify actions for updating the operation of the system based on the performance limitations and/or other information (e.g., service agreements, resources limitations), and/or (iv) perform the actions to increase a likelihood of the system providing the anticipated services in the desired manner.

By updating the operation of the system proactively (e.g., based on anticipated technology), the system may be adapted to provide services that use the latest technology at or prior to a time of adoption of the services. As a result, lead time (e.g., delays) associated the adoption of new technology by the operator may be reduced and/or eliminated.

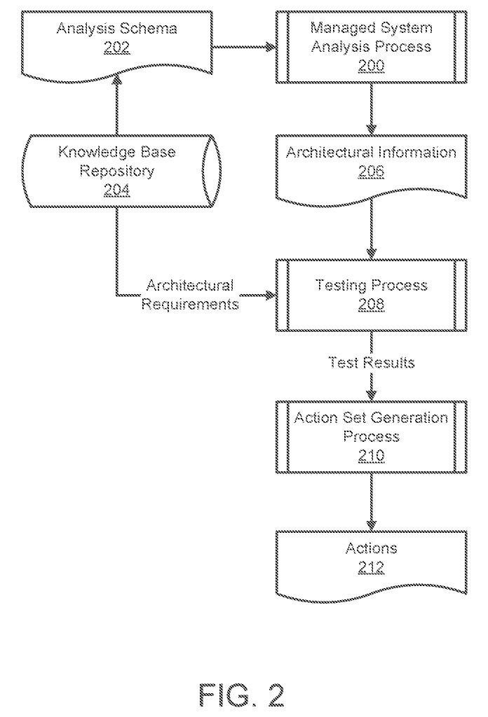

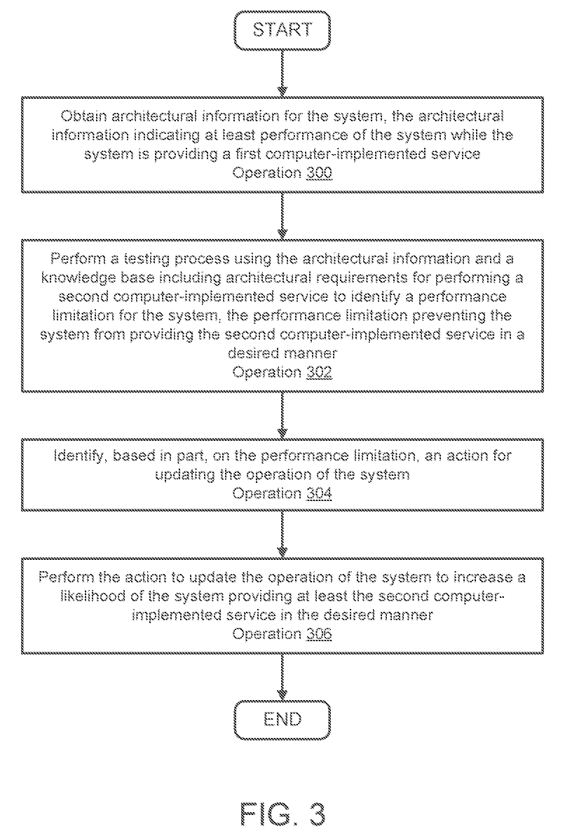

When providing their functionality, any of data processing system 100, managed systems 102, management entity 104, and/or components thereof may perform all, or a portion of the actions and methods illustrated in FIGS. 2-3.

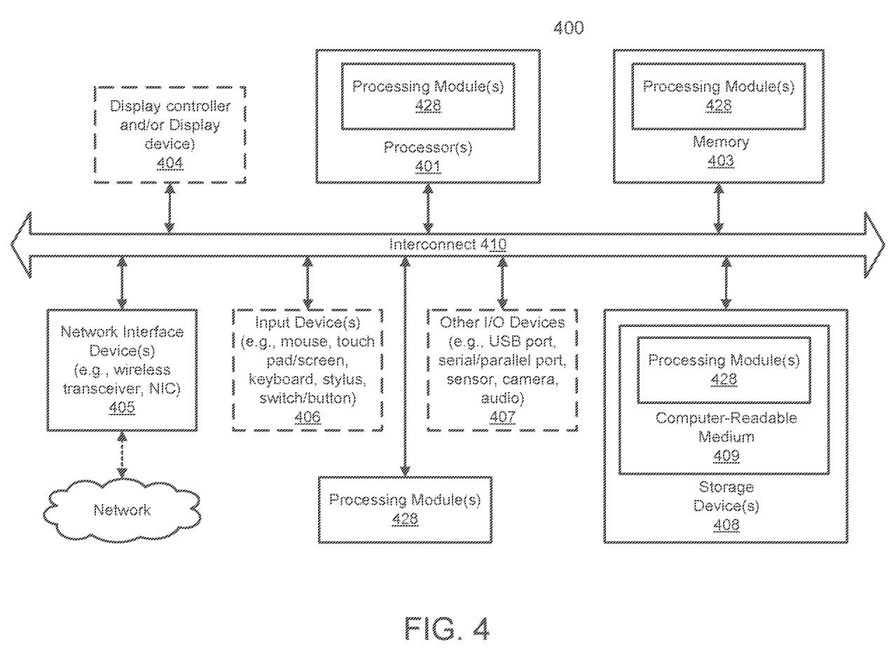

Any of data processing system 100, managed systems 102, and management entity 104 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., smartphone), an embedded system, local controllers, an edge node, and/or any other type of data processing device or system. For additional details regarding computing devices, refer to the discussion of FIG. 4.

Any of the components illustrated in FIG. 1 may be operably connected to each other (and/or components not illustrated) with communication system 106. Communication system 106 may facilitate communications between the components of FIG. 1. In an embodiment, communication system 106 includes one or more networks that facilitate communication between any number of components. The networks may include wired networks and/or wireless networks (e.g., and/or the Internet). The networks and communication devices may operate in accordance with any number and types of communication protocols (e.g., such as the Internet protocol).

While illustrated in FIG. 1 as including a limited number of specific components, a system in accordance with an embodiment may include fewer, additional, and/or different components than those illustrated therein.

To further clarify embodiments disclosed herein, a data flow diagram in accordance with an embodiment is shown in FIG. 2. The data flow diagram may illustrate how data may be obtained and used within the system of FIG. 1.

In the data flow diagram, flows of data and processing of data are illustrated using different sets of shapes. In the context of the data flow diagram, a first set of shapes (e.g., 202, 206, etc.) is used to represent data structures, a second set of shapes (e.g., 208, 210) is used to represent processes performed using and/or that generate data, and a third set of shapes (e.g., 204) is used to represent large scale data structures such as databases.

Turning to FIG. 2, a data flow diagram in accordance with an embodiment is shown. The data flow diagram may illustrate data used in and data processing performed in managing operation of a system. As discussed with respect to FIG. 1, the system may operate (e.g., provide computer-implemented services) within the constraints of its system architecture. For example, the system may include hardware and software components configured to provide a first computer-implemented service in a desired manner.

The system may include a managed system and the system may be adapted (e.g., in terms of at least componentry and/or configuration settings) to provide AI-based services. The operation of the system may be managed by a management entity (e.g., management entity 104) in order to improve adaptability of the system over time with respect to timely adoption of anticipated improvements in AI technology.

To manage the adaptability of the system, the management entity may test the system architecture against architectural requirements for providing a second computer-implemented service (e.g., an anticipated service) in a desired manner. The anticipated service may include an AI-based service that the operator has not yet adopted (e.g., due to being in development); however, the anticipated service may be likely to be adopted by the operator at a future point in time. To test the system architecture, the management entity may obtain architectural information for the system.

The architectural information may include information regarding components of the system, such as (i) software component data for the software components that provide the first computer-implemented service, (ii) hardware component data for the hardware components used by the software components, (iii) configuration settings that define interactions between the components, and/or (iv) other information regarding the system architecture and/or performance of the system during operation. For example, the architectural information may include identifiers for the components and/or other information that may indicate capabilities (e.g., performance capabilities) of the components and/or the system as a whole.

To obtain the architectural information, the management entity may perform managed system analysis process 200. During managed system analysis process 200, analysis schema 202 may be used to obtain (e.g., generate and/or filter) the architectural information to obtain architectural information 206. For example, analysis schema 202 may include (i) a performance test workload (e.g., for generating the architectural information), and/or (ii) information indicating types and/or quantities of (e.g., temporal ranges of) of architectural information required by the management entity to test the system architecture.

Analysis schema 202 may be obtained (e.g., generated) based on information included in knowledge base repository 204. Knowledge base repository 204 (e.g., a knowledge base) may include information usable to measure adaptability of systems with respect to anticipated technological improvements. For example, knowledge base repository 204 may include fundamental hardware, software, and/or configuration requirements for providing different types of anticipated AI-based services.

Knowledge base repository 204 may be based on predictions regarding capabilities required by AI-based services likely to be available for use by an operator of the system at future points in time. For example, knowledge base repository 204 may include information regarding (i) anticipated (e.g., future) improvements in AI-based service technology, (ii) architectural requirements for providing the anticipated AI-based services in a desired manner, and/or (iii) other information (e.g., analysis schemas, information for generating the analysis schemas). For example, the architectural requirements may include operational capabilities (e.g., performance metrics for various components) required to support anticipated AI-based services and/or AI-based services to which the operator is not currently subscribed.

Managed system analysis process 200 may be performed while the system is performing a workload. In a first example, the workload may include a workload performed while providing the first computer-implemented service, and the system may provide architectural information specified by analysis schema 202 to the management entity automatically (e.g., based on a schedule) and/or upon request. In a second example, the workload may include a performance test workload of analysis schema 202, and upon completion of the performance test workload, the system may provide the architectural information specified by analysis schema 202 to the management entity.

Architectural information 206 may include architectural information specified by analysis schema 202. Architectural information 206 may indicate performance of the system as a whole and/or of individual components of the system. For example, architectural information 206 may indicate performance of the system with respect to an output of the workload (e.g., based on workload performance metrics such as a total time to complete the workload and/or a measure of resources used to complete the workload), and/or performance of the components while performing the workload (e.g., based on storage, memory, processing, and/or communication performance metrics).

To test the adaptability (e.g., performance) of the system with respect to the anticipated service (e.g., the second computer-implemented service), the management entity may perform testing process 208. During testing process 208, architectural information 206 and architectural requirements for providing the anticipated service obtained from knowledge base repository 204 may be analyzed to identify a performance limitation that may prevent the system from providing the anticipated service in a desired manner and/or otherwise measure performance of the system with regards to providing the anticipated service.

The architectural requirements obtained from knowledge base repository 204 may include information regarding required types and/or quantities of hardware and/or software components (e.g., required capabilities and/or performance metrics of the components or the system as a whole), and/or required configuration settings. The performance limitation may include a reduction in capabilities of the system over time, and/or architectural limitations that may prevent the anticipated service from being performed.

Architectural information 206 may, for example, indicate that the system is unable to complete the workload in a desired manner (e.g., specified by the architectural requirements) with respect to (i) a quality of the output (e.g., when compared to a quality metric of the architectural requirements and using a first threshold), (ii) a time required to complete the workload (e.g., when compared to a time metric of the architectural requirements and using a second threshold), and/or (iii) other indicator of performance of the system. for example, architectural information 206 may indicate that the system throws an error when attempting to perform the workload.

During testing process 208, analysis of architectural information 206, the architectural requirements, and/or other information may be performed to infer (i) a reduction in capabilities of the system at a future point in time (e.g., based on changes in functionality of the system over time), (ii) failure of (e.g., and/or a time of failure of) a component of the system when the component is placed under load, (iii) a future point in time that the operator of the system is likely to adopt the anticipated service, (vi) a future point in time that services currently provided by the system (e.g., the first computer-implemented service) are rendered obsolete, and/or (v) other information regarding performance of the system over time.

The reduction in capabilities of the system at a future point in time may be inferred based on performance trends for the system (e.g., using historical architectural information and/or historical results of previously performed testing processes). For example, hardware and/or software components of the system may degenerate over time, and a rate of degeneration may be indicated by architectural information 206 and/or historical architectural information for the system obtained by the management entity over time.

The future point in time of adoption of the anticipated service may be based on trends in quality of the first computer-implemented service, adoption rates of new technology by the operator and/or an industry over time (e.g., historical adoption rates), and/or other information.

The future point in time that the first computer-implemented service is rendered obsolete may be based on industry trends, information from developers of the first computer-implemented service, and/or other information.

During testing process 208, the performance limitation and/or other information (e.g., other inferred information discussed above) may be used to identify at least one action managing the system in terms of adaptability to the anticipated service. To obtain the action(s), test results of testing process 208 may be provided to action set generation process 210. The test results may include (i) a description of the performance limitation (e.g., a hardware performance limitation, a software performance limitation, a limitation due to configuration settings for the components, and/or a changes in functionality of the system over time), and/or (ii) a description of the other (inferred) information.

During action set generation process 210, the test results may be analyzed (e.g., by a subject matter expert) to generate actions 212. Actions 212 may include actions for proactively addressing the performance limitation for the system and/or to otherwise modify the system architecture to meet the architectural requirements. For example, a new component (e.g., a new software component, a new hardware component, and/or a new configuration of the components) may be identified to replace an existing component of the system is deemed likely to fail when placed under load, and/or otherwise improve capabilities (e.g., performance capabilities) of the system.

For example, actions 212 may include (i) providing a notification to an operator of the system indicating a recommendation for installing the new component to the system, and/or (ii) obtaining an approval (e.g., from the operator) for installation of the new component to the system. The notification may include, for example, a portion of the test results such as performance metrics for the system over time, a plan for evaluation and/or modification (e.g. replacing, adding, removing) of components over time, information regarding a free trial of the new component, and/or other information.

Other examples of actions 212 may include (i) modifying the system architecture using the new component (e.g., automatically installing the new component to the system without operator approval), and/or (ii) replacing a first component of the system with the new component to reduce load on a second component of the system that is deemed likely to fail when placed under load. For example, a first AI model that generates heavy workloads used in providing the first computer-implemented service may be replaced with a second AI model (e.g., that generates lighter workloads) to reduce load on a hardware component of the system that is deemed likely to fail when placed under the heavy workloads.

At least a portion of actions 212 may be performed (e.g., by the management entity, other entities) to update the operation of the system so that the architectural requirements are met at a point in time prior to the operator adopting the anticipated service, thereby increasing a likelihood of the system providing the anticipated service in the desired manner.

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor-based devices (e.g., computer chips).

Any of the data structures illustrated using the first and third set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

Thus, using the data flow shown in FIG. 2, a managed system may be updated proactively to improve adaptability of the managed systems with respect to anticipated services. An entity that manages the systems may identify performance limitations of the managed systems based on a knowledge base of anticipated technology and/or services likely to be provided by the systems at future points in time. Actions to proactively manage the performance limitation may be performed to update operation of the systems. As a result, the updated systems may be more likely to be equipped for timely adoption of advanced AI-based services.

Turning to FIG. 3, a flow diagram illustrating a method in accordance with an embodiment is shown. The flow diagram may illustrate various operations performed while managing operation of a data processing system.

At operation 300, architectural information for the system may be obtained. The architectural information may be obtained by (i) reading the architectural information from storage, (ii) receiving the architectural information (e.g., from another device), and/or (iii) generating the architectural information.

For example, the architectural information may be generated by the system when performing (a workload for) a first computer-implemented service. The architectural information may indicate performance of the system while the system is providing the first computer-implemented service. Refer to the discussion of managed system analysis process 200 of FIG. 2 for more details regarding obtaining the architectural information.

At operation 302, a testing process may be performed using the architectural information and a knowledge base comprising architectural requirements for providing a second computer-implemented service. The testing process may be performed by methods described with respect to testing process 208 of FIG. 2, and/or by other methods.

For example, performing the testing process may include comparing information included in the architectural information (e.g., performance metrics of the data processing system and/or its components) to information included in the architectural requirements (e.g., required performance metrics for performing the second computer-implemented service in a desired manner) using thresholds. Based on the comparisons, performance gaps (e.g., differences between actual and required performance metrics) may be identified. If a performance gap is not within limits defined by at least one of the thresholds, then the performance gap may be used to identify a performance limitation for the system that prevents the system from providing the second computer-implemented service in a desired manner.

Performing the testing process may include inferring a reduction in capabilities of the system at a future point in time based on changes in functionality of the system over time. The reduction in capabilities may be inferred by, for example, (i) analyzing capabilities of the system using the architectural information and/or historical architectural information for the system (and/or other systems) to identify a trend in functionality over time, and (ii) sampling the trend at a current point in time and at the future point in time to identify measures of capability of the system at each of the points in time, and/or (iii) comparing (e.g., obtaining a difference of) the measures of the capability of the system at each of the points in time to obtain the reduction in capabilities of the system at the future point in time.

Performing the testing process may include inferring a future point in time that an operator of the system is likely to adopt the second computer-implemented service. The future point in time may be inferred by, for example, by analyzing historical adoption rates of related technology (e.g., by an industry, by an operator of the system), likelihoods of adoption of the second computer-implemented service by competitors of an operator of the system, costs associated with adopting the second computer-implemented service (e.g., historical spends by the operator when adopting of related technology), etc.

Performing the testing process may include inferring a future point in time that the first computer-implemented service is rendered obsolete. The future point in time may be inferred by analyzing industry (e.g., technological) trends, information from developers of the first computer-implemented service, and/or other information.

At operation 304, an action for updating the operation of the system may be identified, based in part, on the performance limitation. The action may be identified by performing an action set generation process similar to action set generation process 210 of FIG. 2, and/or by other methods.

For example, the action may be identified by analyzing the performance limitation (e.g., insufficient memory, processing power, etc.) with respect to other information (e.g., inferred information such as future points in time regarding the performance limitation and/or adoption of the second computer-implemented service). Based on the analysis, (i) new components and/or configuration settings may be identified to resolve the performance limitation (e.g., new components with sufficient memory, processing power, etc.), (ii) lead times for obtaining and installing the new components may be identified, and (iii) future points in time for performing the actions may be determined based on the inferred information.

At operation 306, the action may be performed to update the operation of the system. The action may be performed by (i) providing a notification to an operator of the system, the notification indicating a recommendation for installing a new component to the system, and/or (ii) obtaining an approval for installation of the new component to the system.

The notification may be provided to the operator of a system by transmitting a message (e.g. using an email service, using instant messaging service, using a service console) to the operator over a communication system such as communication system 106 of FIG. 1. The approval may be obtained by (i) reading the approval from storage, and/or (ii) receiving the approval from another device (e.g., via the email service, via the instant messaging service, via the service console).

Performing the action may include (i) generating a plan (e.g. a timeline) for updating operation of the data processing system, (ii) sourcing a new component for the data processing system (e.g., providing information to a manufacturer of the new component), (ii) generating a service ticket for installation of the new component to the data processing system (e.g., by a service technician) to update operation of the data processing system, (iii) performing a testing process using architectural information for the updated data processing system to verify that the architectural requirements for providing the second computer-implemented service are met, and/or (iv) other actions that may increase a likelihood of the system providing at least the second computer-implemented service in the desired manner.

The method may end following operation 306.

Thus, as illustrated above, embodiments disclosed herein may provide systems and methods for managing operation of a data processing system in a manner that increases a likelihood of timely adoption of anticipated computer-implemented services by an operator of the data processing system. By doing so, the data processing system may be more likely to provide advanced computer-implemented services as desired by downstream consumers of the services.

Any of the components illustrated in FIGS. 1-3 may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high-level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random-access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a Wi-Fi transceiver, an infrared transceiver, a Bluetooth transceiver, a WiMAX transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid-state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also, a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs, or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components, or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system’s registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g., circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing operation of a system, the method comprising:
obtaining architectural information for the system, the architectural information indicating at least performance of the system while the system is providing a first computer-implemented service;
performing a testing process using the architectural information and a knowledge base comprising architectural requirements for providing a second computer-implemented service to identify a performance limitation for the system, the performance limitation preventing the system from providing the second computer-implemented service in a desired manner;
identifying, based in part, on the performance limitation, an action for updating the operation of the system; and
performing the action to update the operation of the system to increase a likelihood of the system providing at least the second computer-implemented service in the desired manner.

2. The method of claim 1, wherein the system comprises a managed artificial intelligence based system adapted to provide artificial intelligence based services.

3. The method of claim 2, wherein the architectural information comprises information regarding components of the system, the information comprising:
software component data for software components that provide the artificial intelligence based services;
hardware component data for hardware components used by the software components; and
configuration settings that define interactions between the software components and the hardware components.

4. The method of claim 3, wherein the knowledge base is based on predictions regarding capabilities required by artificial intelligence based services likely to be available for use by an operator of the system at a future point in time.

5. The method of claim 3, wherein the testing process comprises:
inferring a reduction in capabilities of the system at a future point in time based on changes in functionality of the system over time.

6. The method of claim 3, wherein the testing process comprises:
inferring a future point in time that an operator of the system is likely to adopt the second computer-implemented service.

7. The method of claim 3, wherein the testing process comprises:
inferring a future point in time that the first computer-implemented service is rendered obsolete.

8. The method of claim 1, wherein the action comprises:
providing a notification to an operator of the system, the notification indicating a recommendation for installing a new component to the system; and
obtaining an approval for installation of the new component to the system.

9. The method of claim 1, wherein the action comprises modifying an architecture of the system using a new component.

10. The method of claim 1, wherein the action comprises replacing use of a first artificial intelligence model for providing the first computer-implemented service with a second artificial intelligence model to reduce load on a hardware component of the system that is deemed likely to fail when placed under load.

11. A non-transitory machine-readable medium having instructions stored therein, which when executed by a processor, cause the processor to perform operations for managing operation of a system, the operations comprising:
obtaining architectural information for the system, the architectural information indicating at least performance of the system while the system is providing a first computer-implemented service;
performing a testing process using the architectural information and a knowledge base comprising architectural requirements for providing a second computer-implemented service to identify a performance limitation for the system, the performance limitation preventing the system from providing the second computer-implemented service in a desired manner;
identifying, based in part, on the performance limitation, an action for updating the operation of the system; and
performing the action to update the operation of the system to increase a likelihood of the system providing at least the second computer-implemented service in the desired manner.

12. The non-transitory machine-readable medium of claim 11, wherein the system comprises a managed artificial intelligence based system adapted to provide artificial intelligence based services.

13. The non-transitory machine-readable medium of claim 12, wherein the architectural information comprises information regarding components of the system, the information comprising:
software component data for software components that provide the artificial intelligence based services;
hardware component data for hardware components used by the software components; and
configuration settings that define interactions between the software components and the hardware components.

14. The non-transitory machine-readable medium of claim 13, wherein the knowledge base is based on predictions regarding capabilities required by artificial intelligence based services likely to be available for use by an operator of the system at a future point in time.

15. The non-transitory machine-readable medium of claim 13, wherein the testing process comprises:
inferring a reduction in capabilities of the system at a future point in time based on changes in functionality of the system over time.

16. A data processing system, comprising:
a processor; and
a memory coupled to the processor to store instructions, which when executed by the processor, cause operations for managing operation of a system to be performed, the operations comprising:
obtaining architectural information for the system, the architectural information indicating at least performance of the system while the system is providing a first computer-implemented service;
performing a testing process using the architectural information and a knowledge base comprising architectural requirements for providing a second computer-implemented service to identify a performance limitation for the system, the performance limitation preventing the system from providing the second computer-implemented service in a desired manner;
identifying, based in part, on the performance limitation, an action for updating the operation of the system; and
performing the action to update the operation of the system to increase a likelihood of the system providing at least the second computer-implemented service in the desired manner.

17. The data processing system of claim 16, wherein the system comprises a managed artificial intelligence based system adapted to provide artificial intelligence based services.

18. The data processing system of claim 17, wherein the architectural information comprises information regarding components of the system, the information comprising:
software component data for software components that provide the artificial intelligence based services;
hardware component data for hardware components used by the software components; and
configuration settings that define interactions between the software components and the hardware components.

19. The data processing system of claim 18, wherein the knowledge base is based on predictions regarding capabilities required by artificial intelligence based services likely to be available for use by an operator of the system at a future point in time.

20. The data processing system of claim 18, wherein the testing process comprises:
inferring a reduction in capabilities of the system at a future point in time based on changes in functionality of the system over time.
